(19) United States
(12) Patent Application Publication
(10) Pub. No.: US 2025/0310411 A1
(43) Pub. Date: Oct. 2, 2025

(54) SYSTEMS AND METHODS FOR NETWORK DISCOVERY

(71) Applicant: ServiceNow, Inc., Santa Clara, CA (US)

(72) Inventors: Varsha Rao, San Diego, CA (US); Robert Jose Dunlap, Bonita, CA (US); Christopher Ryan Orr, The Woodlands, TX (US); Tal Kapon, Givataim (IL); Sai Saketh Nandagiri, San Diego, CA (US); Nisan Bar Zion, San Diego, CA (US)

(21) Appl. No.: 18/620,274

(22) Filed: Mar. 28, 2024

(51) Int. Cl. H04L 67/51; H04L 41/12; H04L 67/1061

(52) U.S. Cl. CPC H04L 67/51; H04L 41/12

(57) ABSTRACT

A method includes receiving, from an agent, information regarding one or more processes associated with one or more devices of a network, determining one or more discovery patterns based on the one or more processes, where the one or more discovery patterns are useable to discover one or more software applications executing or present on the one or more devices, transmitting one or more commands indicative of the one or more discovery patterns to the agent, receiving, from the agent, additional information associated with the one or more software applications based on execution of the one or more commands by the agent, and storing the additional information in a database.

### TECHNICAL FIELD

The present disclosure relates generally to discovery of hardware resources and software resources of a network, and more specifically to discovery of the hardware resources and the software resources using agents deployed on the network.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT), data, and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations. These resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

In modern communication networks, examples of cloud computing services that a user may utilize include so-called infrastructure as a service (IaaS), software as a service (SaaS), and platform as a service (PaaS) technologies. IaaS is a model in which providers abstract away the complexity of hardware infrastructure and provide rapid, simplified provisioning of virtual servers and storage, giving enterprises access to computing capacity on demand. In such an approach, however, a user may be left to install and maintain platform components and applications. SaaS is a delivery model that provides software as a service rather than an end product. Instead of utilizing a local network or individual software installations, software is typically licensed on a subscription basis, hosted on a remote machine, and accessed by client customers as needed. For example, users are generally able to access a variety of enterprise and/or information technology (IT)-related software via a web browser. PaaS acts as an extension of SaaS that goes beyond providing software services by offering customizability and expandability features to meet a user's needs. For example, PaaS can provide a cloud-based developmental platform for users to develop, modify, and/or customize applications and/or automate enterprise operations without maintaining network infrastructure and/or allocating computing resources normally associated with these functions.

In such cloud-based architectures, users may utilize hardware resources and software resources connected via a network. Certain managerial resources may be deployed within the network and may be able to discover and transmit data identifying the hardware resources and/or software resources present on the network. However, such managerial resources may be unable to discover information identifying other software resources (e.g., productivity software, database applications, custom applications, and so forth) executed via the hardware resources. Additionally, certain techniques used to discover software resources may require security credentials to access the hardware resources and/or the software resources, which may cause delays and/or require additional information or authorization (e.g., administrative access or rights) to perform network discovery.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The presently described techniques include techniques for improving discovery of hardware resources and software resources connected via a network using agent(s) deployed within the network itself. As used herein, an “agent” or “software agent” may be understood to be an automated software program or routine configured to perform one or more designated functions while executing in the background on a processor-based device, such as a server or user workstation. For example, an agent as used herein may be a software application deployed within the network, such as on workstations within a local area network, that performs tasks (e.g., discovery related tasks) based on instructions established by IT personnel associated with the network. An agent protocol (e.g., communication channel/connection between a computational instance and a deployed agent) may be used to transmit discovery patterns to the agent, such that the agent does not require security credentials (e.g., administrative rights, and so forth) to perform software discovery. The agent may initially perform the discovery steps of identifying hardware resources and processes executed on the hardware resources and transmitting the hardware resource information and process information to a managerial resource or application running on the computational instance. The computational instance may identify discovery pattern(s) from a database of known discovery patterns based on the process information and transmit the relevant discovery pattern(s) (as determined based on the reported hardware resources and processes) to the agent. The agent may execute the relevant discovery pattern(s) and return identified software application information to the computational instance for action or storage (e.g., input to a database). By way of example, in certain implementations communication between the computational instance and the agent may occur via a Management, Instrumentation, and Discovery (MID) Server (e.g., an intermediary software application), which may have access to the database of known discovery patterns in addition to and/or in place of the computational instance. In general, and as used elsewhere herein, such a device or application may be referred to as a “discovery server”. The discovery patterns may be pre-established and stored in the database and/or may be created or modified based on the process information returned via the initial agent discovery.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present techniques may operate;

FIG. 2 is a schematic diagram of an embodiment of a multi-instance cloud architecture in which embodiments of the present techniques may operate;

FIG. 3 is a block diagram of a computing device utilized in a computing system that may be present in FIG. 1 or 2, in accordance with aspects of the present techniques;

FIG. 4 is a block diagram illustrating a computational instance of a remote network management platform and a client network including agents deployed on hardware resources of the client network and configured to discover and transmit hardware resource information, software resource information, and process information to the computational instance, in accordance with aspects of the present techniques;

FIG. 5 is a swim lane diagram illustrating a process for discovery of software resources by way of communication between the computational instance and the agent, in accordance with aspects of the present techniques;

FIG. 6 is a flow diagram illustrating a process for the computational instance to instruct discovery of software resources by way of the agent, in accordance with aspects of the present techniques; and

FIG. 7 is a flow diagram illustrating a process for the agent to perform discovery of software resources based on instructions received from the computational instance, in accordance with aspects of the present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” or “computer-readable medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code. As used herein, the term “configuration item” or “CI” refers to a record for any component (e.g., computer, device, piece of software, database table, script, webpage, piece of metadata, and so forth) in an enterprise network, for which relevant data, such as manufacturer, vendor, location, or similar data, is stored, such as in a configuration management database (CMDB) or other IT data store. As used herein, an “agent” or “software agent” may be understood to be an automated software program or routine configured to perform one or more designated functions while executing in the background on a processor-based device, such as a server or user workstation.

The present techniques includes techniques for improving discovery of hardware resources and software resources connected via a network using agent(s) deployed on the network. An agent protocol (e.g., communication channel/connection between a computational instance and a deployed agent) may be used to transmit discovery patterns to an agent, such that the agent does not require security credentials used to access the software resources and/or the hardware resources to perform software discovery. The agent may initially perform the discovery steps of identifying hardware resources and processes executed on the hardware resources and transmitting the hardware resource information and process information to the computational instance. The computational instance may identify discovery pattern(s) from a database of known discovery patterns based on the reported process information and transmit the relevant discovery pattern(s) to the agent. The agent may execute the discovery pattern(s) and return identified software application information to the computational instance, where it may be used for reporting or monitoring purposes or stored, such as in a dedicated data store. Communication between the computational instance and the agent may occur via a discovery server, (e.g., a Management, Instrumentation, and Discovery (MID) Server 24 in certain contexts), which may have access to the database of known discovery patterns in addition to and/or in place of the computational instance. The discovery patterns may be pre-established and stored in the database and/or may be created or modified based on the process information returned via agent discovery. Accordingly, the agent may discover information related to the software resources without requiring security credentials used to access the software resources and/or the hardware resources.

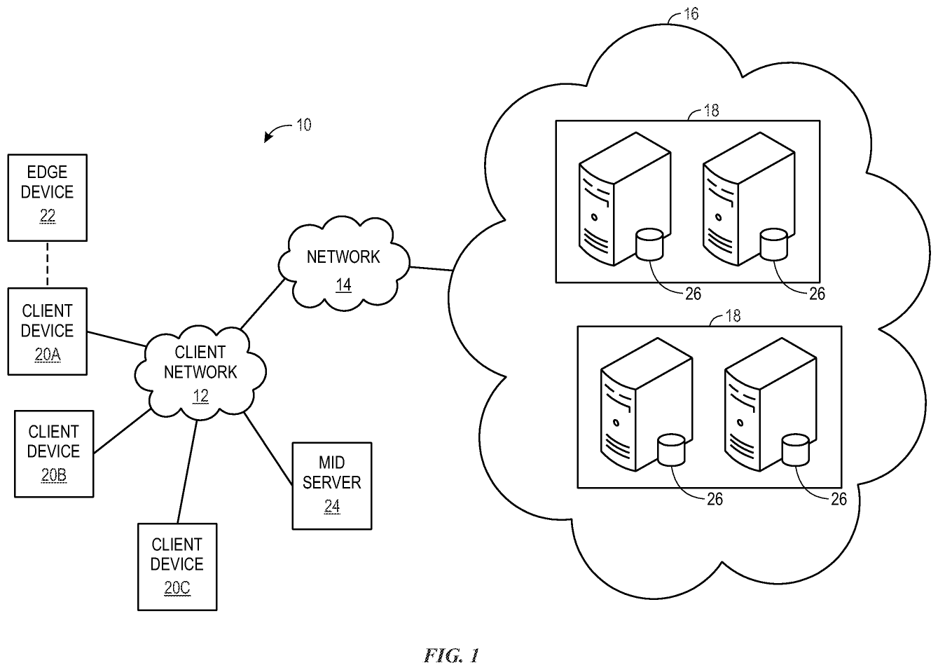

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present techniques may operate, is illustrated. The cloud computing system 10 may include a client network 12, a network 14 (e.g., the Internet), and a cloud-based platform 16 (e.g., a remote network management platform). In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a Management, Instrumentation, and Discovery (MID) Server 24 (which in the present context may be referred to as a discovery server when used in implementing the present discovery-related techniques) that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

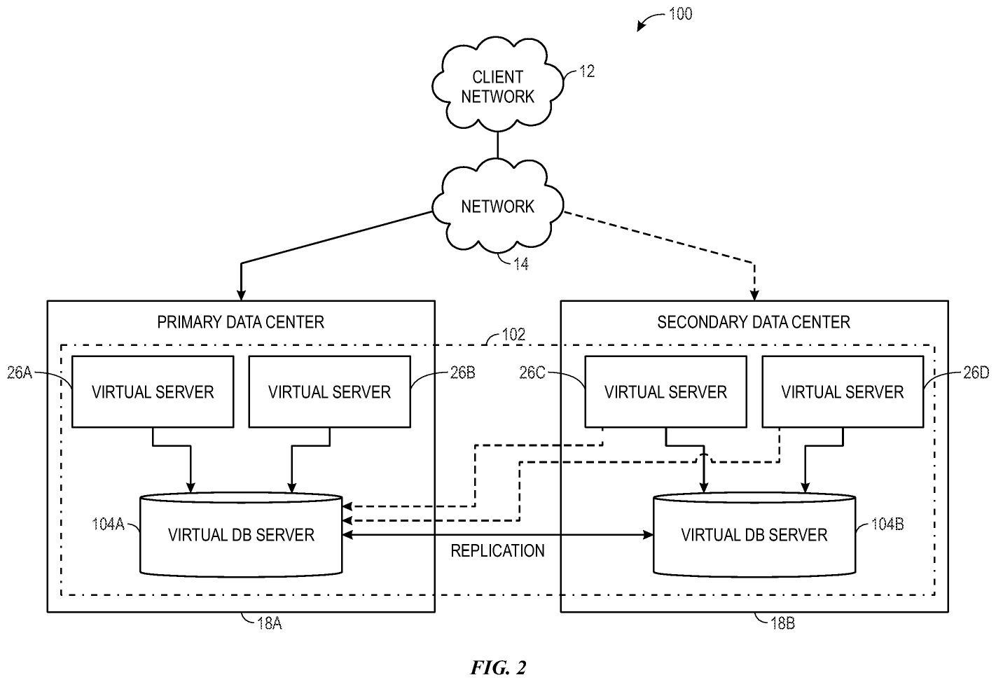

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present techniques may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the presently described techniques are not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present techniques may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the techniques to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

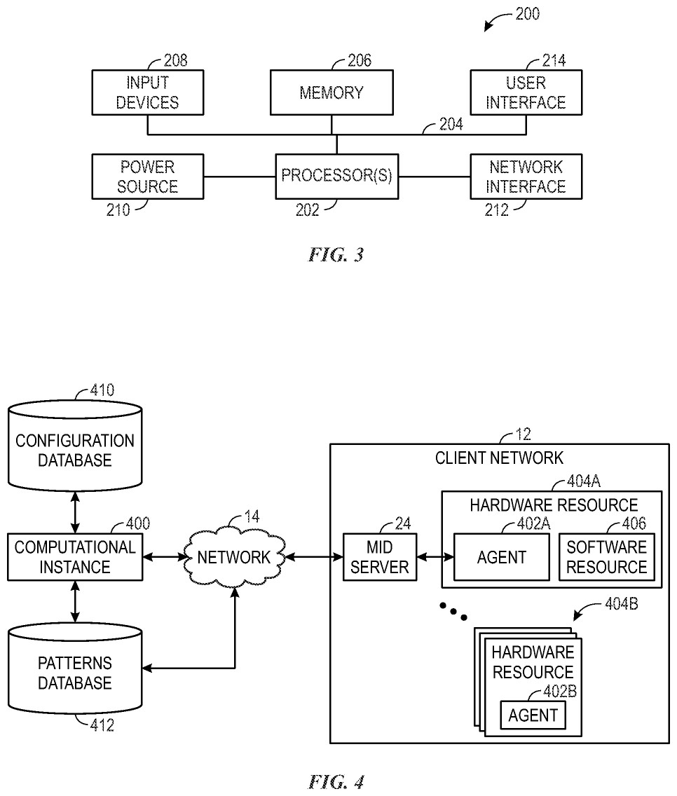

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

With the preceding in mind, FIG. 4 is a block diagram illustrating a computational instance 400 of a remote network management platform and the client network 12. Agents 402 may be deployed (e.g., installed) on hardware resources 404 of the client network 12 and configured to discover and transmit hardware resource information, software resource information, and process information to the computational instance 400. In certain embodiments, the computational instance 400 may be similar to or include the client instance 102. Additionally, the agents 402 may be deployed on the hardware resources 404 of the client network 12 by the remote network management platform. As illustrated, the client network 12 is communicatively connected to and/or includes a hardware resource 404A having an agent 402A and one or more additional hardware resources 404B with each hardware resource 404B having an agent 402B. In certain embodiments, some or all of the additional hardware resources 404B may be omitted and/or some or of the additional hardware resources 404B may not have the agent 402B installed thereon. The hardware resources 404 may include computing devices, load balancers, firewalls, switches, and other types of hardware resources. The software resources 406 may generally include software applications, such as productivity software, database applications, custom applications, and other types of software resources. For illustrative purposes, the hardware resource 404A includes one software resource 406. However, each hardware resource 404 may have any number of software resources 406 installed thereon (e.g., no software resources 406, one software resources 406, two software resources 406, five software resources 406, ten software resources 406, twenty software resources 406, one hundred software resources 406).

Each agent 402 may be an automated software application configured to perform one or more designated functions (e.g., targeted network hardware and/or software discovery as discussed herein) while executing in the background on a processor-based device, such as a server or user workstation. For example, each agent 402 may be used to perform discovery operations, among other IT operations. The IT operations may be established and configured by IT personnel of an enterprise associated with the client network 12. The agents 402 may include one or more specific-purpose agents dedicated to discovery operations and/or one or more multi-purpose agents dedicated to other operations in addition to discovery operations, such as monitoring operations, reporting operations, and/or other suitable operations.

As discussed herein, the agents 402 may be useable to discover the software resources 406 deployed (e.g., installed) on the hardware resources 404. For example, the agents 402 may communicate with the computational instance 400 via the MID server 24 (or more generally a discovery server) and a certain protocol (e.g., an established protocol), such as secure shell (SSH) commands, among other types of protocols. Each agent 402 may transmit information to the discovery server, and the discovery server may transmit the information to the computational instance 400. Likewise, the computational instance 400 may transmit instructions (e.g., commands) to the discovery server, and the discovery server (e.g., MID server 24) may transmit the instructions to the agents 402. In this manner, the discovery server may be a central software application for the collection and/or disbursement of information and instructions, such as information and instructions related to discovery processes. In certain embodiments, the discovery server may be omitted, the computational instance 400 may communicate directly with the agents 402 and vice versa.

For illustrative purposes, discovery of software resources of the client network 12 is described in reference to the agent 402A and the hardware resource 404A and a single software resource 406. However, the discovery of software resources of the client network 12 may be performed via other installed agents 402B present on the client network 12 to discover software resources installed on the hardware resources 404B.

In the present example, the agent 402A may initiate and transmit registration information to the discovery server (e.g., MID server 24), which may include identification information of the software application (e.g., a discovery application, an IT management application, and so forth) represented by the agent. The agent 402A may initiate automatically, such as periodically (e.g., hourly, daily, weekly) and/or in response to an occurrence of another action (e.g., a hardware resource connecting to the client network 12). In certain embodiments, the agent 402A may initiate in response to instructions established by IT personnel.

The discovery server may transmit the registration information to the computational instance 400, and the computational instance 400 may authenticate the agent 402A. For example, the computational instance 400 may access a database including identification information of agents that have been deployed on the client network 12 by the remote network management platform. The computational instance 400 may compare the registration information associated with the agent 402A with the identification information stored in the database to confirm that the agent 402A is an agent deployed by the remote network management platform to authenticate the agent 402A.

In response to authenticating the agent 402A, the computational instance 400 may instruct the agent 402A to perform a discovery operation (e.g., an initial discovery operation, a first discovery operation, a basic discovery operation) associated with the hardware resource 404A. For example, the computational instance 400 may transmit the initial discovery instructions/commands to the agent 402A via the discovery server. In response to receiving the initial discovery instructions, the agent 402A may perform the initial discovery operation and collect information associated with the hardware resource 404A (e.g., identification information of the hardware resource 404A) and processes executed by and/or on the hardware resource 404A. The agent 402A may transmit the information associated with the hardware resource 404A and the processes to the computational instance 400 via the discovery server. Accordingly, the computational instance 400 may initiate the discovery process upon determining that the agent 402A is an authentic agent deployed by the remote network management platform, thereby ensuring that an appropriate agent is performing the discovery process. In certain embodiments, authentication of the agent 402A may be omitted, and the agent 402A may perform the initial discovery operation associated with the hardware resource 404A automatically and/or in response to instructions established by IT personnel.

In response to receiving the information associated with the hardware resource 404A and the processes executed by and/or on the hardware resource 404A, the computational instance 400 may update and/or create configuration items stored in a configuration management database 410 (e.g., a CMDB, a configuration database of the remote network management platform) based on the hardware resource 404A and the processes executed by and/or on the hardware resource 404A. Each configuration item may represent a particular hardware resource, a portion or component of a hardware resource, a software resource (e.g., an application), a portion of a software resource (e.g., a module or update), relationship(s) between a hardware resource and a software resource, and/or other components associated with the client network 12.

Additionally, in response to receiving the information associated with the hardware resource 404A and the processes executed by and/or on the hardware resource 404A, the computational instance 400 may determine one or more discovery patterns usable by the agent 402A to discovery software resources on the client network 12 based on the received process information, such as the software resource 406. For example, the computational instance 400 may analyze the discovered processes to determine attributes and/or other aspects of the software resources indicated by the process information. The computational instance 400 may access a patterns database 412 (e.g., a patterns database of the remote network management platform) and identify patterns stored in the patterns database 412 usable by the agent 402A to discovery software resources based on the attributes and/or the other aspects of the software resources. For example, the patterns database 412 may store executable instructions representative of patterns that the agents 402 may execute to discover software resources of the client network 12 as determined based on information previously returned by the agent 402A. The patterns may be pre-established patterns, such as patterns previously created by the computational instance 400, previously created based on other discovery operations, and/or previously created by the remote network management platform generally (e.g., by personnel operating within the remote network management platform) based on established parameters associated with the client network 12. In certain embodiments, the computational instance 400 may create new patterns based on the received process information and store the newly created patterns in the patterns database 412, and/or the computational instance 400 may modify the pre-established patterns stored in the patterns database 412 based on the received process information. In certain embodiments, the computational instance 400 and/or another component of the remote management platform may generate a representation of a graphical user interface (GUI) configured to display code indicative of the patterns stored in the patterns database 412 and/or of a newly generated pattern, such that a user interacting with the GUI may view and/or modify the patterns. Additionally, the user may write executable code indicative of a new pattern via the GUI, and the computational instance 400 may store the new pattern in the patterns database 412. The computational instance 400 may transmit the representation of the GUI for display on a device of the client network 12, such that a user of the client network 12 is able to interact with the GUI. Additionally or alternatively, the computational instance 400 may transmit the representation of the GUI for display on a device of the remote network management platform, such that a user of the remote network management platform is able to interact with the GUI.

For illustrative purposes, the computational instance 400 is described as determining one discovery pattern usable by the agent 402A to discovery software resources of the client network 12. In certain embodiments, the computational instance 400 may determine multiple discovery patterns usable by the agent 402A to discovery software resources of the client network 12. In response to determining the discovery pattern based on the discovered process information and/or the patterns stored in the patterns database 412, the computational instance 400 may transmit the discovery pattern (e.g., executable instruction(s) indicative of the discovery pattern) to the agent 402A via the discovery server. In response to receiving the discovery pattern, the agent 402A may execute the discovery pattern to discover (e.g., receive, collect) information associated with software resources of the client network. In the illustrated embodiment, the agent 402A may discover information associated with the software resource 406. The information associated with the software resource 406 may include identification information of the software resource 406, attributes of the software resource 406, relationships between the software resource 406 and the hardware resource 404A, relationships between the software resource 406 and other hardware resources of the client network 12, relationships between the software resource 406 and other software resources of the client network 12, and other information associated with components of the client network 12.

In response to discovering the information associated with the software resource 406, the agent 402A may transmit the information to the computational instance 400 via the discovery server. In response to receiving the information, the computational instance 400 may update and/or create one or more configuration items of the configuration database 410 based on the received information. For example, the computational instance 400 may create and/or update a configuration item representative of the software resource 406, create and/or update a configuration item representative of an attribute and/or portion of the software resource 406, and/or create and/or update one or more configuration items representative of one or more relationships between the software resource 406 and the hardware resource 404A, other hardware resources of the client network 12, other software resources of the client network 12, and/or other suitable components of the client network 12.

Accordingly, the computational instance 400 of the remote network management platform may discover, via the agents 402, information associated with hardware resources and software resources of the client network 12 and update the configuration database 410 based on the discovered information. In certain embodiments, the agents 402 may perform the discovery operations associated with the hardware resources and the software resources without the use of security credentials that may otherwise be required to access the software resources. In particular, the computational instance 400 may communicate with the agents 402 via an established protocol and instruct the agents 402 to perform discovery of the software resources based on the discovery patterns described herein. As such, the discovery process described herein may reduce delays associated with discovery and require less information to perform discovery.

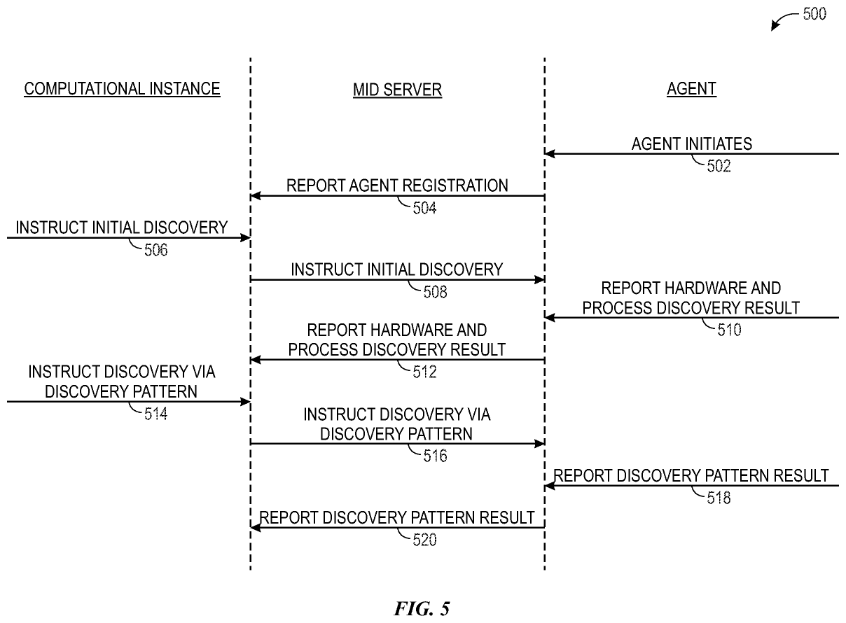

FIG. 5 is a swim lane diagram illustrating a process 500 for discovery of the software resources 406 by way of communication between the computational instance 400 and the agent 402. Although the following description of the process 500 is described as including certain steps performed in a particular order, it should be understood that the steps of the process 500 may be performed in any suitable order, that certain steps may be omitted, and/or that certain steps may be added.

At step 502, the agent 402A may initiate and transmit registration information to the discovery server (e.g., MID server 24), which may include identification information of the software application represented by the agent. At step 504, the discovery server may report (e.g., transmit) the registration information to the computational instance 400. The computational instance 400 may authenticate (e.g., verify, confirm) that the agent 402A is an agent deployed within the client network 12 by the remote network management platform.

At steps 506 and 508, in response to authenticating the agent 402A, the computational instance 400 may instruct the agent 402A, by way of the discovery server (e.g., MID server 24), to perform a discovery operation associated with the hardware resource 404A, such as to discover information related to the hardware resource 404A and/or processes executed by and/or on the hardware resource 404A. The agent 402A may execute the instructions to discover the information related to the hardware resource 404A and/or the processes executed by and/or on the hardware resource 404A. At steps 510 and 512, the agent 402A may transmit, by way of the discovery server, the results of the initial discovery operation to the computational instance 400. In response to receiving the information related to the hardware resource 404A and/or the processes executed by and/or on the hardware resource 404A (e.g., the result of the initial discovery operation), the computational instance 400 may update and/or create one or more configuration items of the configuration database 410 based on the received information.

Additionally, the computational instance 400 may determine one or more discovery patterns usable by the agent 402A to discovery software resources on the client network 12 based on the received process information. At steps 514 and 516, the computational instance 400 may transmit, by way of the discovery server, instructions to execute the one or more discovery patterns to the agent 402A. The agent 402A may execute the instructions to discover information related to the software resource 406 based on the one or more discovery patterns, among other software resources of the client network 12.

At steps 518 and 520, the agent 402A may transmit, by way of the discovery server, the discovered information related to the software resource 406 to the computational instance 400. In response to receiving the information related to the software resource 406, the computational instance 400 may update and/or create one or more configuration items of the configuration database 410 based on the received information related to the software resource 406.

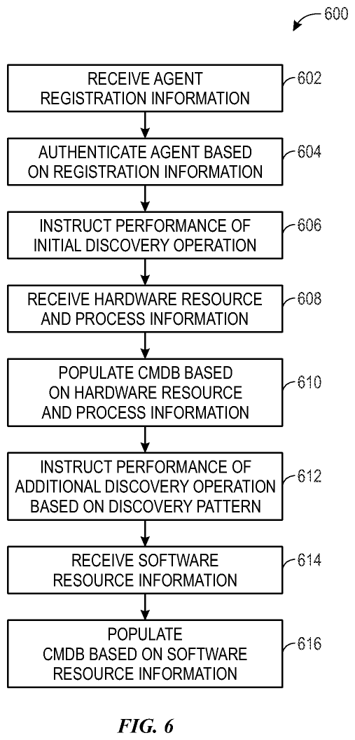

FIG. 6 depicts a flow diagram illustrating a process 600 for the computational instance 400 to instruct discovery of the software resource 406 by way of the agent 402A. Although the following description of the process 600 is described as including certain steps performed in a particular order, it should be understood that the steps of the process 600 may be performed in any suitable order, that certain steps may be omitted, and/or that certain steps may be added.

At block 602, the computational instance 400 may receive agent registration information representative of the agent 402A. At block 604, the computational instance 400 may authenticate that the agent 402A is an agent deployed within the client network 12 by the remote network management platform, such as by comparing the registration information with a database of known registration information associated with agents deployed on the client network 12 by the remote network management platform.

At block 606, the computational instance 400 may instruct performance of an initial discovery operation, such as by transmitting executable instructions configured to be executed by the agent 402A to discover hardware resources of the client network 12, among other aspects of the client network 12. At block 608, the computational instance 400 may receive the result of the initial discovery operation, such as information related to the hardware resource 404A and/or processes executed by and/or on the hardware resource 404A. At block 610, the computational instance 400 may populate the configuration database 410 (e.g., update and/or create one or more configuration items of the configuration database 410) based on the received information.

Additionally, the computational instance 400 may determine one or more discovery patterns usable by the agent 402A to discovery software resources on the client network 12 based on the received process information. At block 612, the computational instance 400 may instruct performance of an additional discovery operation based on the one or more determined discovery patterns, such as by transmitting executable instructions indicative of the one or more determined discovery patterns. At block 614, the computational instance may receive software resource information (e.g., information associated with the software resource 406) discovered (e.g., collected) as a result of execution of the executable instructions indicative of the one or more determined discovery patterns by the agent 402A. At step 616, computational instance 400 may populate the configuration database 410 (e.g., update and/or create one or more configuration items of the configuration database 410) based on the received information associated with the software resource 406.

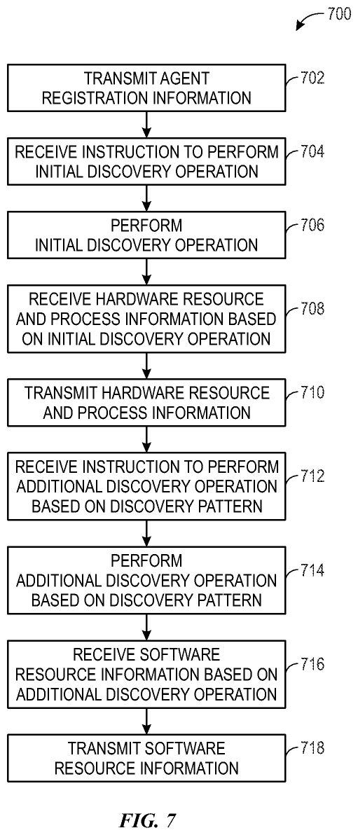

FIG. 7 depicts a flow diagram illustrating a process 700 for the agent 402A to perform discovery of the software resource 406 based on instructions received from the computational instance 400. Although the following description of the process 700 is described as including certain steps performed in a particular order, it should be understood that the steps of the process 700 may be performed in any suitable order, that certain steps may be omitted, and/or that certain steps may be added.

At block 702, the agent 402A may transmit registration information representative of the agent 402A. At block 704, the agent 402A may receive instruction(s) to perform an initial discovery operation, such as executable instructions configured to discover information associated with the hardware resource 404A and/or other components of the client network 12. At 706, the agent 402A may execute the executable instructions to perform the initial discovery operation. At block 708, the agent 402 may receive information related to the hardware resource 404A and/or processes executed by and/or on the hardware resource 404A based on execution of the initial discovery operation. At block 710, the agent 402A may transmit the information related to the hardware resource 404A and/or processes executed by and/or on the hardware resource 404A.

At block 712, the agent 402A may receive instruction(s) to perform an additional discovery operation based on one or more discovery patterns, such as executable instructions indicative of the one or more discovery patterns. The one or more discovery patterns may be based on the process information discovered during the initial discovery operation. At block 714, the agent 402A may execute the instructions indicative of the one or more discovery patterns. At block 716, the agent 402A may receive information associated with the software resource 406 based on execution of the instructions indicative of the one or more discovery patterns. At block 718, the agent 402A may transmit the information associated with the software resource 406.

The presently disclosed techniques improve discovery of hardware resources and software resources connected via a network using agent(s) deployed on the network by utilizing discovery patterns and locally installed agents deployed on the hardware on which discovery is performed. In particular, the discovery patterns may be determined based on information associated with processes executed on the network and determined, or expected, to be present on a respective device based on an initial discovery operation. The agents may be existing software applications deployed on the network by a remote network management platform, such that the remote network management platform already has an established communication protocol with the agents for communication of instruction to perform the discovery operation. For example, a computational instance of the remote network management platform may receive initial discovery information indicative of the processes executed on the network, determine the discovery patterns based on the process information, and transmit instructions to perform an additional discovery operation based on the discovery patterns to the agents. The agents may perform the additional discovery operation to discover information associated software resources of the network without the use of security credentials that are typically required to access and perform discovery of such software resources. In particular, instructions may be communicated to the agent via an established protocol allowing security credential or authentication steps to be bypassed. Accordingly, the present techniques may reduce delays associated with discovery and require less information to perform discovery, thereby improving an efficiency and an ease of use associated with network discovery.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A processor-based method, comprising:
receiving, from an agent, information regarding one or more processes associated with one or more devices of a network;
determining one or more discovery patterns based on the one or more processes, wherein the one or more discovery patterns are useable to discover one or more software applications executing or present on the one or more devices;
transmitting one or more commands indicative of the one or more discovery patterns to the agent;
receiving, from the agent, additional information associated with the one or more software applications based on execution of the one or more commands by the agent; and
storing the additional information in a database.

2. The method of claim 1, wherein determining the one or more discovery patterns based on the one or more processes comprises identifying the one or more discovery patterns from a plurality of discovery patterns stored in a pattern database based on the one or more processes.

3. The method of claim 2, comprising modifying at least one discovery pattern of the plurality of discovery patterns based on the one or more processes, generating a new discovery pattern based on the one or more processes, or both.

4. The method of claim 1, comprising providing a user interface configured to display code representative of the one or more discovery patterns, receive an input indicative of a modification to the one or more discovery patterns, receive an input indicative of a new discovery pattern, or any combination thereof.

5. The method of claim 1, wherein the one or more commands comprise one or more secure shell (SSH) commands.

6. The method of claim 1, wherein the agent comprises a software application installed on a device of the one or more devices.

7. The method of claim 1, comprising:
receiving the information, the additional information, or both, from the agent via a discovery server; and
transmitting the one or more commands indicative of the one or more discovery patterns to the agent via the discovery server.

8. The method of claim 1, wherein the agent is configured to execute the one or more commands indicative of the one or more discovery patterns without the use of security credentials used to access or manage the one or more software applications.

9. A processor-based method, comprising:
receiving, by an agent, information regarding one or more devices of a network and one or more processes associated with the one or more devices;
transmitting, by the agent, the information to a computational instance of a remote network management platform;
receiving, by the agent, one or more commands indicative of one or more discovery patterns from the computational instance;
receiving, by the agent, additional information associated with one or more software applications based on execution of the one or more commands; and
transmitting, by the agent, the additional information to the computational instance.

10. The method of claim 9, wherein the agent comprises a software application installed on a device of the one or more devices.

11. The method of claim 9, wherein the agent comprises a special-purpose agent devoted to discovery operations or a multi-purpose agent devotes to discovery operations and other types of operations.

12. The method of claim 9, comprising:
transmitting, by the agent, the information, the additional information, or both, to the computational instance via a discovery server; and
receiving, by the agent, the one or more commands indicative of the one or more discovery patterns from the computational instance via the discovery server.

13. The method of claim 12, wherein the discovery server comprises a software application operable within the network.

14. The method of claim 9, wherein the agent is configured to execute the one or more commands indicative of the one or more discovery patterns without the use of security credentials used to access the one or more software applications.

15. The method of claim 9, comprising:
transmitting, by the agent, initial information indicative of registration of the agent to the computational instance; and
in response to the computational instance verifying the registration of the agent, receiving, by the agent and from the computational instance, one or more initial commands indicative of instructions to obtain the information regarding the one or more devices and the one or more processes associated with the one or more devices.

16. A system, comprising:
one or more processors; and
a non-transitory memory storing instructions that, when executed by the one or more hardware processors, cause the one or more processors to perform actions comprising:
receiving, from a plurality of agents, information regarding processes associated with devices of a network;
determining one or more discovery patterns based on the processes, wherein the one or more discovery patterns are useable to discover software applications of the network;
transmitting one or more commands indicative of the one or more discovery patterns to the plurality of agents;
receiving, from the plurality of agents, additional information associated with the software applications based on execution of the one or more discovery patterns by the plurality of agents; and
storing the additional information in a database.

17. The system of claim 16, wherein determining the one or more discovery patterns based on the processes comprises identifying the one or more discovery patterns from a plurality of discovery patterns stored in a pattern database.

18. The system of claim 16, wherein the actions comprise modifying at least one discovery pattern of the plurality of discovery patterns based on the processes, generating a new discovery pattern based on the processes, or both.

19. The system of claim 16, wherein the plurality of agents is configured to execute the one or more commands indicative of the one or more discovery patterns without the use of security credentials used to access the software applications.

20. The system of claim 16, wherein the actions comprise:
receiving the information, the additional information, or both, from the plurality of agents via a discovery server; and
transmitting the one or more commands indicative of the one or more discovery patterns to the plurality of agents via the discovery server.
